(19) United States
(12) Patent Application Publication
(10) Pub. No.: US 2024/0088422 A1
(43) Pub. Date: Mar. 14, 2024

(54) Loading Plate for a Fuel Cell System and the Fuel Cell System

(71) Applicant: Robert Bosch GmbH, Stuttgart (DE)

(72) Inventor: Sascha Ambrock, Wuxi (CN)

(21) Appl. No.: 18/456,698

(22) Filed: Aug. 28, 2023

(30) Foreign Application Priority Data
Sep. 8, 2022 (CN) 2022 2239 7592.8

(51) Int. Cl. H01M 8/2404; H01M 8/248; H01M 8/249

(52) U.S. Cl. CPC H01M 8/2404; H01M 8/248; H01M 8/249; H01M 2250/20

(57) ABSTRACT

A loading plate for a fuel cell system is disclosed. A loading plate is configured to carry at least two cell stack assemblies. Each cell stack assembly includes a stack, a first end plate member and a second end plate member that grips the stack, and a fluid joint extending from the stack through the first end plate member. The loading plate includes opposing first and second surfaces and a plurality of apertures extending from the first surface through the loading plate to the second surface. Each aperture is configured to correspond to one of the fluid joints of the at least two cell stack assemblies. The loading plate is configured to carry at least two cell stack assemblies on the first surface such that the first end plate member is mounted on the first surface and such that the fluid joint extends through the plurality of apertures. Also disclosed is a fuel cell system that includes the aforementioned loading plate.

This application claims priority under 35 U.S.C. § 119 to patent application no. CN 2022 2239 7592.8, filed on Sep. 8, 2022 in China, the disclosure of which is incorporated herein by reference in its entirety.

The present disclosure relates generally to fuel cell technologies, in particular, to a loading plate for a fuel cell system and the fuel cell system including such loading plate.

### BACKGROUND

Fuel cell systems that generate power by electrochemically reacting with fuel and oxidants are increasingly being used to provide power. Hydrogen fuel cell systems are widely used fuel cell systems that use hydrogen as a fuel and oxygen as an oxidant. The hydrogen fuel cell system comprises an cell stack assembly and an enclosed housing. A cell stack assembly is used to convert chemical energy in hydrogen fuels and oxidants into electrical energy. An enclosed housing is used to carry the cell stack assembly and provide encapsulation and protection for the cell stack assembly. An enclosed housing comprises a loading plate for carrying an cell stack assembly and a housing mounted on the loading plate to enclose and enclose the cell stack assembly.

As the demand for high-power hydrogen fuel cell systems increases, it is desirable to include multiple cell stack assemblies in a single hydrogen fuel cell system. However, in the existing hydrogen fuel cell systems, a separate enclosed housing is used for each of a plurality of cell stack assemblies, i.e., a separate loading plate and housing are used for each cell stack assembly. This results in low integration and significant footprint of hydrogen fuel cell systems.

Therefore, improvements to existing fuel cell systems are needed.

### SUMMARY

The present disclosure is intended to provide an improved loading plate to improve the integration of the fuel cell system. The present disclosure provides a loading plate for a fuel cell system. The loading plate is configured to carry at least two cell stack assemblies, each comprising a stack of battery cells, a first end plate member and a second end plate member respectively disposed at opposite ends of the stack, and a fluid joint extending from the stack through the first end plate member. The loading plate comprises: opposing first and second surfaces; and a plurality of apertures extending from the first surface through the loading plate to the second surface, each of the apertures configured to correspond to one of the fluid joints of the at least two cell stack assemblies. The loading plate is configured to carry the at least two cell stack assemblies on the first surface such that the first end plate member of the at least two cell stack assemblies is mounted on the first surface and such that the fluid joints of the at least two cell stack assemblies extend through the plurality of apertures.

In some examples, the first end plate member of each of the cell stack assemblies comprise: a fixed plate configured to grip the stack therebetween with the second end plate member; an active plate disposed on an opposite side of the fixed plate and an elastic member disposed between the fixed plate and the active plate. Each of the cell stack assemblies further comprises a plurality of strapping tapes with each of the plurality of strapping tapes bypassing the second end plate member and both ends being connected to the active plate to hold the second end plate member, the stack, the fixed plate, the elastic member, and the active plate together, wherein the plurality of strapping tapes are each in a tight state and the elastic member is in a compressed state. The loading plate further comprises at least two recesses recessed from the first surface into the loading plate, each recess being configured to correspond to one of the first end plate members of the at least two cell stack assemblies, the loading plate being configured such that when the at least two cell stack assemblies are carried on the first surface, the fixed plate of each cell stack assembly is fixed on the first surface, and the elastic member and the active plate are disposed in the recess.

In some examples, the loading plate further comprises a set of the protruding ribs that protrude around each of the recesses of the first surface, the protruding ribs comprising a top surface and a threaded blind hole extending from the top surface through the protruding ribs into the loading plate, the loading plate being configured such that when the at least two cell stack assemblies are carried on the first surface, the fixed plate is disposed on a top surface of a respective set of the protruding ribs, a bolt extending through the fixed plate into the threaded blind hole to fix the fixed plate on the top surface of the corresponding set of protruding ribs, and the elastic member and the active plate being disposed in a space defined by the recess and the corresponding set of protruding ribs.

In some examples, the first end plate member of each of the cell stack assemblies comprises: a fixed plate disposed to grip the stack with the second end plate member; an active plate disposed on the fixed plate at the opposite side of the stack; an elastic member disposed between the fixed plate and the active plate; each of the cell stack assemblies comprises a plurality of strapping tapes with each of the plurality of strapping tapes bypassing the second end plate member and both ends connected to the active plate to hold the second end plate member, the stack, the fixed plate, the elastic member and the active plate together, wherein the plurality of strapping tapes are in a tight state and the elastic member is in a compressed state, the loading plate comprising at least two sets of protruding ribs protruding from the first surface, the protruding ribs comprising a top surface and a threaded blind hole extending from the top surface into the loading plate through the protruding ribs, the loading plate being configured such that when at least two cell stack assemblies are carried on the first surface, the fixed plate of each of the cell stack assemblies being disposed on the top surface of the corresponding set of protruding ribs of the at least two sets of protruding ribs, a bolt extending through the fixed plate into the threaded blind hole to fix the fixed plate on the top surface of a corresponding set of protruding ribs, and the elastic member and the active plate being disposed in a space defined by the corresponding set of protruding ribs.

In some examples, the fluid joints comprise a fuel inlet joint, a fuel outlet joint, an oxidant inlet joint, an oxidant outlet joint, a coolant inlet joint, and a coolant outlet joint. In some examples, the elastic member comprises a spring.

In some examples, at least one of the two ends of each strapping tape is adjustable to the active plate such that the length of the strapping tape extending between the active plate and the second end plate member can be adjusted to adjust a retaining force applied by the strapping tape to the second end plate member and the active plate.

The present disclosure also provides a fuel cell system. The fuel cell system comprises: at least two stack assemblies, each comprising a stack of battery cells, a first end plate member and a second end plate member respectively disposed at opposite ends of the stack to grip the stack, and a fluid joint extending from the stack through the first end plate member; and a loading plate carrying the at least two cell stack assemblies, the loading plate comprising opposing first surface and second surface and a plurality of apertures extending from the first surface to the second surface through the loading plate, each of the plurality of apertures being configured to correspond to a fluid joint of the at least two cell stack assemblies. The at least two cell stack assemblies are carried on the first surface of the loading plate such that the first end plate member of the at least two cell stack assemblies is mounted on the first surface and such that the fluid joints of the at least two cell stack assemblies extend through the plurality of apertures.

In some examples, the first end plate member of each of the cell stack assemblies comprises: a fixed plate configured to grip the stack with the second end plate member therebetween; an active plate disposed on the fixed plate at the opposite side of the stack; an elastic member disposed between the fixed plate and the active plate; each cell stack assembly further comprises a plurality of strapping tapes with each of the plurality of strapping tapes bypassing the second end plate member and both ends being connected to the active plate to hold the second end plate member, the stack, the fixed plate, the elastic plate, and the active plate together. The plurality of strapping tapes are each in a tight state and the elastic member is in a compressed state; the loading plate further comprises at least two recesses in the loading plate that are recessed from the first surface, each of the recesses being configured to correspond to one of the first end plate members of the at least two cell stack assemblies. The fixed plate of each of the cell stack assemblies is fixed on the first surface and the elastic member and the active plate are disposed in the recess.

In some examples, the loading plate further comprises a set of the protruding ribs protruding from each of the recesses to the first surface, the protruding ribs comprising a top surface and a threaded blind hole extending from the top surface into the loading plate through the protruding ribs, the fixed plate of each of the cell stack assemblies being mounted on a top surface of a respective set of protruding ribs, a bolt extending through the fixed plate into the threaded blind hole to fix the fixed plate on a top surface of the respective set of the protruding ribs, and the elastic member and the active plate being disposed in a space defined by the recess and the respective set of protruding ribs.

In some examples, the first end plate member of each of the cell stack assemblies comprises: a fixed plate disposed to grip the stack therebetween with the second end plate member; an active plate disposed in the fixed plate at the opposite side of the stack; and an elastic member disposed between the fixed plate and the active plate. Each of the cell stack assemblies further comprises a plurality of strapping tapes with each of the plurality of strapping tapes bypassing the second end plate member and both ends being connected to the active plate to hold the second end plate member, the stack, the fixed plate, the elastic member, and the active plate together, wherein the plurality of strapping tapes are each in a tight state and the elastic member is in a compressed state. The loading plate further comprises at least two sets of protruding ribs protruding from the first surface, the protruding ribs comprising a top surface and a threaded blind hole extending from the top surface through the protruding ribs into the loading plate. The at least two cell stack assemblies are carried on the first surface of the loading plate, the fixed plate of each of the cell stack assemblies is mounted on a top surface of a respective set of protruding ribs of the at least two sets of protruding ribs, a bolt extending through the fixed plate into the threaded blind hole to fix the fixed plate on a top surface of the respective set of protruding ribs, and the elastic member and the active plate are disposed in a space defined by the respective set of the protruding ribs.

In some examples, the at least two cell stack assemblies share a housing mounted on the loading plate to surround and enclose the at least two cell stack assemblies.

In some examples, the fluid joint includes a fuel inlet joint, a fuel outlet joint, an oxidant inlet joint, an oxidant outlet joint, a coolant inlet joint, and a coolant outlet joint.

In some examples, the elastic member comprises a spring.

In some examples, at least one of the two ends of each strapping tape is adjustable to the active plate such that the length of the strapping tape extending between the active plate and the second end plate member can be adjusted to adjust a retaining force applied by the strapping tape to the second end plate member and the active plate.

The present disclosure can improve the integration of the fuel cell system, make it compact in layout, and reduce footprint.

### BRIEF DESCRIPTION OF THE DRAWINGS

The above and other aspects of the present disclosure will be understood and appreciated more thoroughly below in connection with the appended drawings. It should be noted that the drawings are merely illustrative and not drawn by scale. In the appended drawings:

FIG. 1 is a front-bottom stereoscopic view of a fuel cell system comprising a loading plate, according to a preferred example of the present disclosure;

FIG. 2 is a partial exploded view of the fuel cell system shown in FIG. 1;

FIG. 3 is a front-top stereoscopic view of the two stack assemblies and loading plate of the fuel cell system shown in FIG. 2;

FIG. 4 is a front-top stereoscopic view of the loading plate shown in FIG. 3;

FIG. 5 is a front-bottom stereoscopic view of one of the two cell stack assemblies shown in FIGS. 2-3;

FIG. 6 is a rear-top stereoscopic view of the cell stack assembly shown in FIG. 5;

FIG. 7 is a side view of the cell stack assembly shown in FIG. 5;

FIG. 8 is a cross-sectional view of the cell stack assembly shown in FIG. 5 taken along line “I-I” of FIG. 7;

and

FIG. 9 is a cross-sectional view similar to that of FIG. 8, but illustrating the mounting of the cell stack assembly to the loading plate.

### LIST OF APPENDED DRAWINGS

1 Fuel Cell System
3 Electrical Stack Assembly
5 Stack
7 First end plate member
9 Second end plate member
11a Fuel Inlet Joint
11b Fuel Outlet Joint
13a Oxidant Inlet Joint
13b Oxidant Outlet Joint
15a Coolant Inlet Joint
15b Coolant Outlet Joint
17 Housing
17a Side Housing
17b Top Cover
19 Strapping Tape
19a First End
19b Second End
19c Tape Body
19d Cylindrical Joint
51 Stacking Direction
71 Fixed Plate
73 Active Board
75 Elastic Member
100 Carrier Plate
100a First Surface
100b Second Surface
105 Aperture
107 Recess
109 Protruding Rib
109a Top Surface
109b Threaded Blind Hole
300 Bolt
400 Adjustment Bolt

### DETAILED DESCRIPTION

Some preferred examples of the present disclosure are described in detail below in conjunction with the example. It should be understood by one skilled in the art that these examples are exemplary only and are not meant to create any limitation on the present disclosure. Further, the features in the examples of the present disclosure may be combined with one another without conflict.

In the drawings, other components are omitted for brevity, but this does not indicate that the fuel cell system, cell stack assembly, loading plate, and housing of the present disclosure may not comprise other structures and components. It should be understood that the dimensions, the proportional relationship and the number of various structures and components in the drawings are not a limitation to the present disclosure.

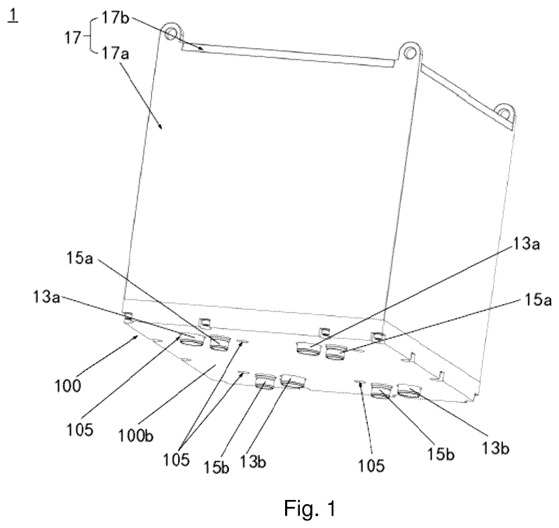

FIGS. 1-3 schematically illustrate a fuel cell system 1 according to a preferred example of the present disclosure. The fuel cell system 1 can be a hydrogen fuel cell system, in particular a proton exchange membrane fuel cell (PEMFC) system, which uses hydrogen as the fuel and oxygen as the oxidant. The fuel cell system 1 may be used in a vehicle to provide power, thus driving a vehicle motor to provide power or to cause an onboard system to perform various functions. It should be understood that the present disclosure is not to be so limited.

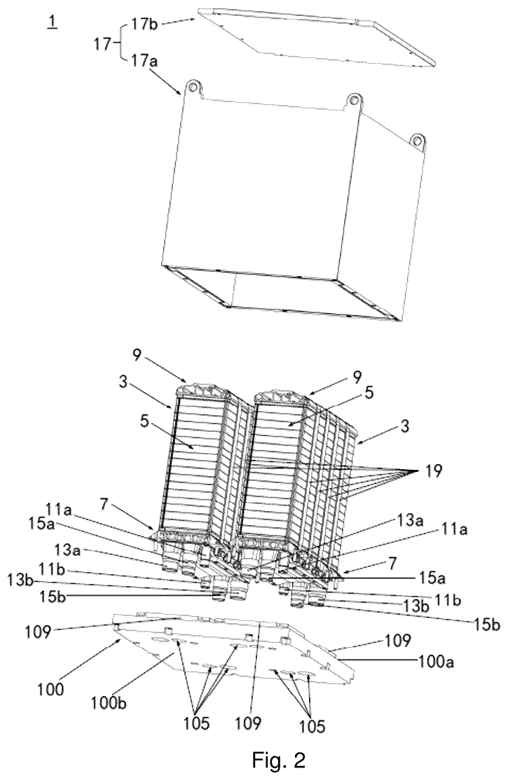

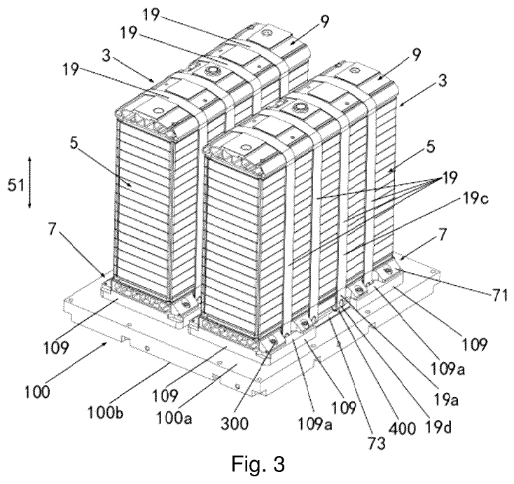

As shown in FIGS. 2 and 3, the fuel cell system 1 comprises at least two cell stack assemblies 3. Each stack assembly 3 comprises a stack 5 laid up by battery cells, a first end plate member 7 and a second end plate member 9 disposed at opposite ends of the stack 5 to grip the stack 5 respectively, and a fluid joint extending from the stack 5 through the first end plate member 7 (11a-11b, 13a-13b, and 15a-15b in the drawings). The battery cells of each cell stack assembly 3 may be connected in series and at least two cell stack assemblies 3 may be connected in series or in parallel.

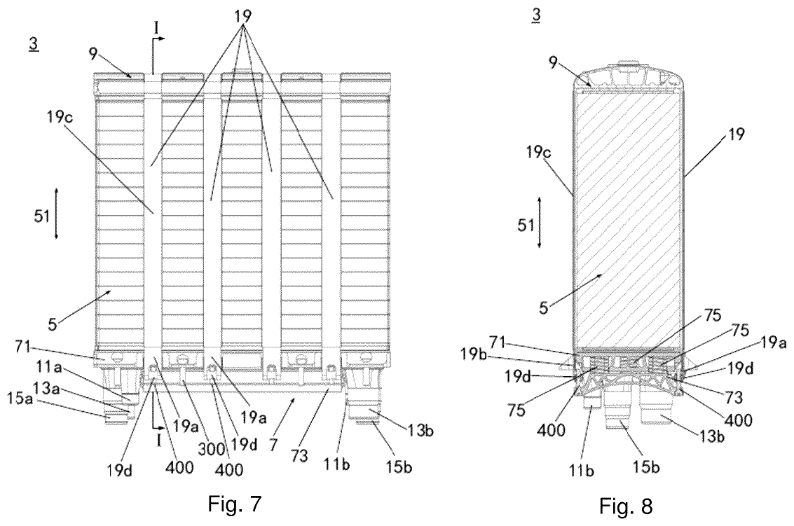

The plurality of battery cells are stacked along the stacking direction 51 (FIGS. 7-9) to form the stack 5. Each battery cell is typically constructed by a cathodic plate, an anodic plate, a protic exchange film, a cathodic diffusion layer and a cathodic catalytic layer between the cathodic plate and the protic exchange film, an anodic diffusion layer and an anodic cathodic layer between the anodic plate and the protic exchange film (not specifically shown in the figure). The cathodic diffusion layer, the cathodic layer structure, the anodic diffusion layer, the anodic catalytic layer, and the protic exchange film are generally made into one, and are referred to as a membrane electrode assembly (MEA). The cathodic diffusion layer and the anodic diffusion layer are used to support the cathodic catalytic layer and the anodic catalytic layer, respectively, and transmit reaction fluid and reaction products (hydrogen, oxygen/air, water, etc.). The MEA is disposed between the cathodic plate and the anodic plate to form a battery cell. The cathodic plate and the anodic plate form a cathodic flow field and an anodic flow field, respectively. The cathodic flow field of the cathodic plate of the plurality of battery cells is capable of forming the cathodic flow channel of the stack 5 of the cell stack assembly 3, and the anodic flow field of the anodic plate of the plurality of battery cells is capable of forming the anodic flow channel of the stack 5 of the cell stack assembly 3.

The electrochemical reaction of the cell stack assembly 3 occurs in MEA and is mainly involved in the hydrooxidation (HOR) process and the oxygen reduction (ORR) process. H₂ and O₂ are transferred to the anodic catalytic layer and the cathodic catalytic layer by the anodic diffusion layer and the cathodic diffusion layer, respectively, where H₂ loses the electrons under the anodic catalyst to form the H⁺. H⁺ is transferred to the cathodic side by a protic exchange film, binding with O₂ to form H₂O under the cathode catalyst at the cathodic catalytic layer. H₂O is transferred through the cathodic diffusion layer and the anodic diffusion layer to the cathodic flow field and the anodic flow field, and then discharged out of the stack 5 of the cell stack assembly 3 through the cathodic flow channel and the anodic flow channel. The electrons then flow to the cathode through an external circuit (not shown) to form a current.

An anodic plate of one battery cell of two adjacent battery cells may be fixed with the cathodic plate of the other fuel cell in a way that the anodic and cathodic flow fields are opposite each other to define a coolant flow field therebetween. The coolant flow field of the plurality of battery cells is capable of forming the coolant flow channel of the stack 5 of the cell stack assembly 3.

The first end plate member 7 and the second end plate member 9 are disposed at opposite ends of the stack 5 in the stacking direction 51 to grip the stack 5 and hold the plurality of battery cells together. The fluid joint extends from the stack 5 through the first end plate member 7. The fluid joints may comprise, for example, a fuel inlet joint 11a, a fuel outlet joint 11b, an oxidant inlet joint 13a, an oxidant outlet joint 13b, a coolant inlet joint 15a, and a coolant outlet joint 15b.

The fuel inlet joint 11a may be configured to communicate with the inlet of the anodic flow channel of the stack 5 of the cell stack assembly 3 for supplying fuel gas (specifically hydrogen) to the anodic flow channel of the stack 5 of the cell stack assembly 3 for distribution to the anodic flow field of various battery cells. The fuel outlet joint 11b may be configured to communicate with the outlet of the anodic flow channel of the stack 5 of the cell stack assembly 3 for discharging the reaction products (typically, the product water, unconsumed fuel gas, and inactive gas) at the anodic side out of the stack 5 of the cell stack assembly 3. The fuel inlet joint 11a and the fuel outlet joint 11b may be connected to a fuel subsystem (not shown) of the fuel cell system 1.

The oxidant inlet joint 13a may be configured to communicate with the inlet of the cathodic flow channel of the stack 5 of the cell stack assembly 3 for supplying the oxidant (specifically oxygen or air) to the cathodic flow channel of the stack 5 of the cell stack assembly 3 for distribution to the cathodic flow field of various battery cells. The oxidant outlet joint 13b may be configured to communicate with the outlet of the cathodic flow channel of the stack 5 of the cell stack assembly 3 for discharging the reaction products (typically the product water, unconsumed oxidant, and inactive gas) at the cathodic side out of the stack 5 of the cell stack assembly 3. The oxidant inlet joint 13a and the oxidant outlet joint 13b may be connected to an air subsystem (not shown) of the fuel cell system 1.

The coolant inlet joint 15a may be configured to communicate with an inlet of the coolant flow channel of the stack 5 of the cell stack assembly 3 for supplying the coolant to the coolant flow field of the respective battery cell. The coolant outlet joint 15b may be configured to communicate with the outlet of the coolant flow channel of the stack 5 of the cell stack assembly 3 for discharging the heat exchange coolant out of the stack 5 of the cell stack assembly 3. The coolant inlet joint 15a and the coolant outlet joint 15b may be connected to a thermal management subsystem (not shown) of the fuel cell system 1.

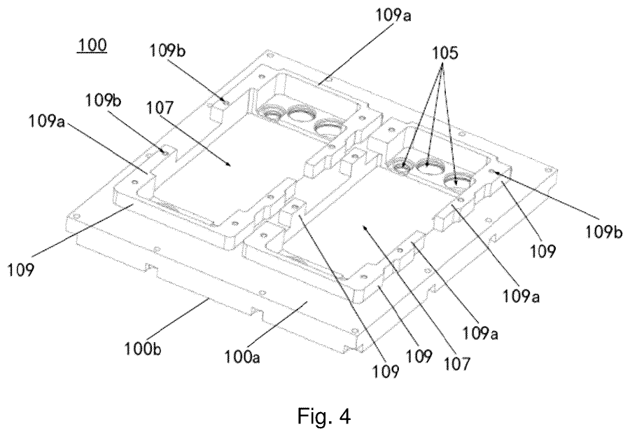

As shown in FIGS. 1-3, the fuel cell system 1 further comprises a loading plate 100 configured to carry at least two cell stack assemblies 3. As best shown in FIGS. 3-4, the loading plate 100 comprises opposing first surface 100a and second surface 100b and a plurality of apertures 105 extending from the first surface 100a through the loading plate 100 to the second surface 100b. Each aperture 105 is configured to correspond to one of the fluid joints (e.g., a fuel inlet joint 11a, a fuel outlet joint 11b, an oxidant inlet joint 13a, an oxidant outlet joint 13b, a coolant inlet joint 15a, and a coolant outlet joint 15b) of at least two cell stack assemblies 3. The loading plate 100 is configured to carry at least two cell stack assemblies 3 on the first surface 100a such that a first end plate member 7 of the at least two cell stack assemblies 3 is mounted on the first surface 100a (FIG. 3) of the loading plate 100 and such that the fluid joints of the at least two cell stack assemblies 3 extend through a plurality of apertures 105 (FIG. 1) of the loading plate 100.

The inventors have recognized that this configuration of the loading plate 100 of the fuel cell system 1 enables the integration of at least two cell stack assemblies 3 on a single loading plate 100. This can increase the integration of the fuel cell system 1, make it compact in layout, and reduce footprint. Moreover, this configuration of the loading plate 100 of the fuel cell system 1 causes each of the cell stack assemblies 3 to be mounted on the first surface 100a of the loading plate 100 through the first end plate member 7, which facilitates assembly and disassembly of the cell stack assembly 3 and improves the efficiency of the production and maintenance of the fuel cell system 1. Further, the fluid joints of the cell stack assembly 3 extend through the plurality of apertures 105 of the loading plate 100, facilitating the concentration of the fluid joints of the cell stack assembly 3 at the loading plate 100, thereby facilitating fluid wiring and connection of the fuel cell system 1.

It should be understood that the loading plate 100 may be made of any suitable material. For example, the loading plate 100 may be made of the aluminum alloy. A sealing ring (not shown) may be disposed between the aperture 105 of the loading plate 100 and the fluid joint of the cell stack assembly 3 to achieve the sealing performance.

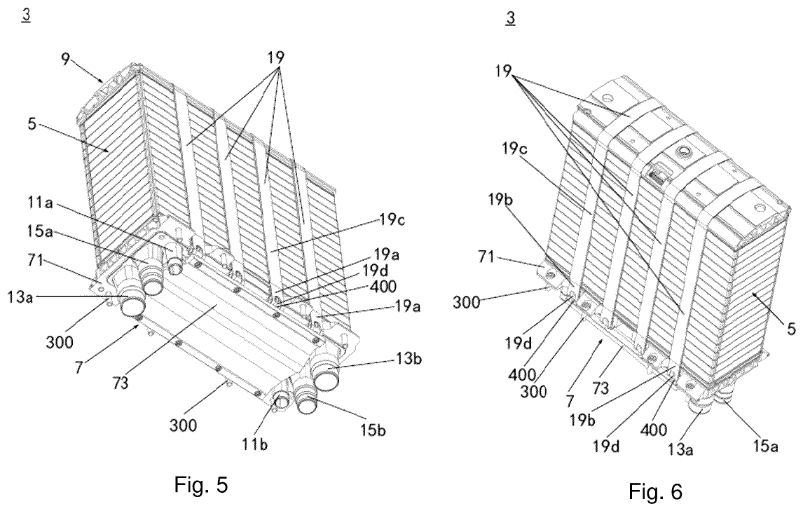

FIGS. 5-8 illustrate schematically one of the two cell stack assemblies 3 shown in FIGS. 2-3. As shown in FIGS. 5-8, a first end plate member 7 of each cell stack assembly 3 comprises: a fixed plate 71 configured to grip the stack 5 therebetween with the second end plate member 9; an active plate 73 disposed on the fixed plate 71 at the opposite side of the stack 5; and an elastic member 75 (FIG. 8) disposed between the fixed plate 71 and the active plate 73. The elastic member 75 may comprise a spring, a leaf, or any other suitable form of elastic member.

Continually referring to FIGS. 5-8, each cell stack assembly 3 further comprises a plurality of strapping tapes 19. The strapping tape 19 may be made of any suitable material. For example, the strapping tape 19 may be made of the aluminum alloy. Each strapping tape 19 bypasses the second end plate member 9 and both ends are connected to the active plate 73 to hold the second end plate member 9, the stack 5, the fixed plate 71, the elastic member 75, and the active plate 73 together. The plurality of strapping plates 19 are each in a tight state and the elastic member 75 is in a compressed state.

In particular, each strapping tape 19 comprises opposing first end 19a and second end 19b, and a tape body 19c extending between the first end 19a and the second end 19b. The first end 19a of the strapping tape 19 is connected to the active plate 73, the tape body 19c extends from the active plate 73 and bypasses the second end plate member 9, with the second end 19b being connected to the active plate 73. In this way, the strapping tape 19 holds the second end plate member 9, the stack 5, the fixed plate 71, the elastic member 75, and the active plate 73 together. The elastic member 75 disposed between the fixed plate 71 and the active plate 73 is in a compressed state and acts between the fixed plate 71 and the active plate 73. As will be described below, the fixed plate 71 is fixed on the first surface 100a of the loading plate 100. In this way, the elastic member 75 applies pressure to the active plate 73 to make the strapping tape 19 in a tight state. The strapping tape 19 in a tight state in turn fix the second end plate member 9 and the stack to the fixed plate 71. With this configuration, a constant griping load can be ensured to the stack 5, thereby maintaining a constant contact resistance between the MEA of the battery cells and the anodic and cathodic plates.

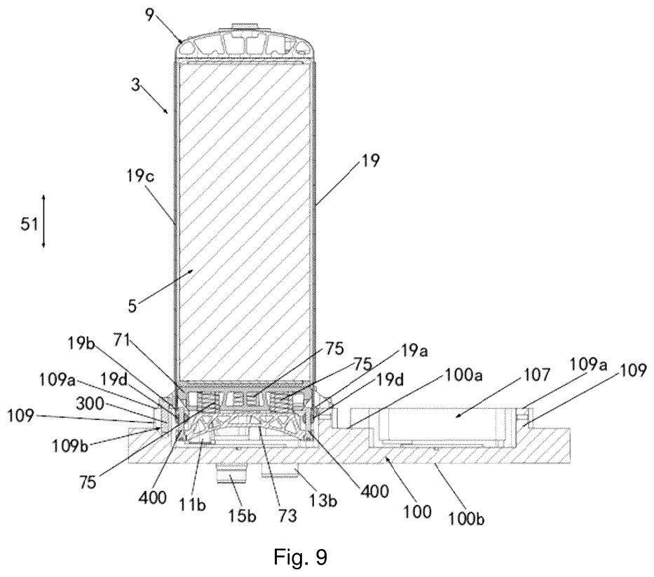

In some examples, as shown in FIGS. 4 and 9, the loading plate 100 further comprises at least two recesses 107 recessed from the first surface 100a into the loading plate 100. Each recess 107 is configured to correspond to one of the first end plate members 7 of the at least two cell stack assemblies 3. The loading plate 100 is configured such that when at least two cell stack assemblies 3 are carried on the first surface 100a, the fixed plate 71 of each cell stack assembly 3 is fixed on the first surface 100a, and the elastic member 75 and the active plate 73 are disposed in the recess 107. In this way, the height of the cell stack assembly 3 may be lowered, which further reduces the footprint of the fuel cell system 1 and facilitates the miniaturization of the fuel cell system 1.

In one of these examples, as shown in FIGS. 4 and 9, the loading plate 100 further comprises a set of protruding ribs 109 that protrude out of the first surface 100a and surrounds each recess 107. Each of the protruding ribs 109 comprises a top surface 109a and a threaded blind hole 109b extending from the top surface 109a through the protruding ribs 109 into the loading plate 100. The loading plate 100 is configured such that when at least two cell stack assemblies 3 are carried on the first surface 100a, the fixed plate 71 of each cell stack assembly 3 is mounted on a top surface 109a of a respective set of protruding ribs 109, and the bolt 300 (FIGS. 3 and 9) extends through the fixed plate 71 into the threaded blind hole 109b to fix the fixed plate 71 on the top surface 109a of the respective set of protruding ribs 109, and the elastic member 75 and the active plate 73 are disposed in a space defined by the recess 107 and the respective set of protruding ribs 109. In this way, a threaded mounting structure can be provided at the first surface 100a of the loading plate 100 to enable the cell stack assembly 3 to be bolted onto the loading plate 100 to achieve integration of the fuel cell system. The threaded blind hole 109b extends from the top surface 109a of the protruding ribs 109 through the protruding ribs 109 into the loading plate 100 to form deeper threaded holes, providing a more stable threaded mounting structure without overly increasing the thickness of the loading plate 100. Further, the threaded blind hole 109b is provided, rather than a through hole, ensuring the air tightness of the loading plate 100, and providing reliable protection for the cell stack assembly 3. It should be understood that each set of the protruding ribs 109 may comprise one or more protruding ribs 109.

In other partial examples, the loading plate 100 may be devoid of the recess 107 and instead comprise only at least two sets of protruding ribs 109 protruding above the first surface 100a. Similarly, each of the protruding tabs 109 comprises a top surface 109a and a threaded blind hole 109b extending from the top surface 109a through the protruding ribs 109 into the loading plate 100. The loading plate 100 is configured such that when at least two cell stack assemblies 3 are carried on the first surface 100a, the fixed plate 71 of each cell stack assembly 3 is disposed on the top surface 109a of the corresponding set of protruding ribs 109 of the at least two sets of the protruding ribs 109, the bolt 300 extending through the fixed plate 71 into the threaded blind hole 109b to fix the fixed plate 71 on the top surface 109a of the respective set of protruding ribs 109, and the elastic member 75 and the active plate 73 being disposed in a space defined by the respective set of protruding ribs 109. In this way, a threaded mounting structure can be provided at the first surface 100a of the loading plate 100 to enable the cell stack assembly 3 to be bolted onto the loading plate 100 to achieve the integration of the fuel cell system. A threaded blind hole 109b is provided, rather than a through hole, ensuring the air tightness of the loading plate 100, and providing reliable protection for the cell stack assembly 3. It should be understood that each set of protruding ribs 109 may comprise one or more protruding ribs 109.

In some examples, at least one of the two ends of each strapping tape 19 (i.e., first end 19a and/or second end 19b) is adjustable to the active plate 73 such that the length of the strapping tape 19 extending between the active plate 73 and second end plate member 9 can be adjusted to adjust the retaining force applied by the strapping tape 19 to the second end plate member 9 and the active plate 73. As shown in FIGS. 5-9, the first end 19a and/or the second end 19b of the strapping tape 19 may be configured to wrap around the cylindrical joint 19d, and the cylindrical joint 19d may be connected to the active plate 73 of the first end plate member 7 by the adjustment bolt 400. The adjustment bolt 400 helps to adjust the length of the strapping tape 19 extending between the active plate 73 and the second end plate member 9, thereby adjusting the retaining force applied by the strapping tape 19 to the second end plate member 9 and the active plate 73. It should be understood that the present disclosure is not so limited. For example, the first end 19a and/or the second end 19b of the strapping tape 19 may also be connected to the active plate 73 of the first end plate member 7 via a adjustment mechanism such as a hook to enable length adjustment.

Returning to FIGS. 1 and 2, at least two of the cell stack assemblies 3 of the fuel cell system 1 may share a housing 17. The housing 17 is mounted on the loading plate 100 to surround and enclose at least two cell stack assemblies 3. By having at least two cell stack assemblies 3 of the fuel cell system 1 to share a housing 17, the degree of integration of the fuel cell system 1 may be further improved and the footprint is reduced. In some examples, as shown in FIGS. 1 and 2, the housing 17 may comprise a side housing 17a and a top cover 17b. The side housing 17a may enclose a receptacle space for at least two cell stack assemblies 3 of the fuel cell system 1 and the loading plate 100 and the top cover 17b enclose the receptacle space. It should be understood that the housing 17 may be in other suitable forms and that the present disclosure is not so limited.

The inventors also propose a loading plate 100 that comprises the foregoing features. The loading plate 100 may be used in a fuel cell system to improve the integration of the fuel cell system, make it compact in layout, and reduce footprint.

It should be understood that while the loading plate 100 and the fuel cell system 1 described above in connection with the first end plate member 7 and the second end plate member 9 are hold together with the strapping tape 15, it is understood that the first end plate member 7 and the second end plate member 9 of the cell stack assemblies 3 may also be connected by a screw to hold the battery cells together, and the present disclosure is not so limited.

It should also be understood that the terms “first” and “second” are only used to distinguish one element or portion from another, but these elements and/or portions should not be limited by such terms.

The present disclosure is described in detail above with reference to the specific examples. Obviously, the above description and the examples shown in the drawings should be understood as exemplary and not constitute a limitation to the present disclosure. Various variants or modifications may be made to the art without departing from the spirit of the present disclosure, neither of which are outside the scope of the present disclosure.

What is claimed is:

1. A loading plate for a fuel cell system, wherein the loading plate is configured to carry at least two cell stack assemblies, each of the at least two cell stack assemblies comprises a stack laid up by battery cells, opposing ends respectively disposed in the stack to grip the first end plate member and the second end plate member, and a fluid joint extending from the stack through the first end plate member, the loading plate comprising:
opposing first surface and second surface; and
a plurality of apertures extending from the first surface through the loading plate to the second surface, each aperture configured to correspond to one of the fluid joints of the at least two cell stack assemblies;
wherein the loading plate is configured to carry the at least two cell stack assemblies on the first surface such that the first end plate member of the at least two cell stack assemblies is mounted on the first surface and such that the fluid joints of the at least two cell stack assemblies extend through the plurality of apertures.

2. The loading plate according to claim 1, wherein:
the first end plate member of each of the cell stack assemblies comprises:
a fixed plate configured to grip the stack therebetween with the second end plate member;
an active plate disposed on the opposite side of the fixed plate to the stack; and
an elastic member disposed between the fixed plate and the active plate;
each of the cell stack assemblies further comprising a plurality of strapping tapes, each of the plurality of strapping tapes bypassing the second end plate member and both ends connected to the active plate to hold the second end plate member, the stack, the fixed plate, the elastic member, and the active plate together, wherein the plurality of strapping tapes are each in a tight state and the elastic member is in a compressed state; and
the loading plate further comprises at least two recesses in the loading plate recessed from the first surface, each recess configured to correspond to one of the first end plate member of the at least two cell stack assemblies, the loading plate configured to cause the fixed plate of each cell stack assembly to be fixed on the first surface and the elastic member and the active plate to be disposed in the recess when the at least two cell stack assemblies are carried on the first surface.

3. The loading plate according to claim 2, wherein:
the loading plate further comprising a set of protruding ribs protruding around each of the recesses on the first surface, the protruding ribs comprising a top surface and a threaded blind hole extending from the top surface into the loading plate through the protruding ribs; and
the loading plate is configured such that, when the at least two cell stack assemblies are carried on the first surface, the fixed plate of each of the cell stack assemblies is mounted on a top surface of a respective set of protruding ribs, a bolt extending through the fixed plate into the threaded blind hole to fix the fixed plate to the top surface of the corresponding set of protruding ribs, and the elastic member and the active plate being disposed in the space defined by the recess and the corresponding set of protruding ribs.

4. The loading plate according to claim 1, wherein:
the first end plate member of each of the cell stack assemblies comprises:
a fixed plate disposed to grip the stack therebetween with the second end plate member;
an active plate disposed on the opposite side of the fixed plate to the stack; and
an elastic member disposed between the fixed plate and the active plate;
each of the cell stack assemblies further comprising a plurality of strapping tapes with each of the plurality of strapping tapes bypassing the second end plate member and ends connected to the active plate to hold the second end plate member, the stack, the fixed plate, the elastic member, and the active plate together, wherein the plurality of strapping tapes are each in a tight state and the elastic member is in a compressed state;
the loading plate further comprising at least two sets of protruding ribs protruding from the first surface, the protruding ribs comprising a top surface and a threaded blind hole extending from the top surface into the loading plate through the protruding ribs; and
the loading plate is configured such that, when the at least two cell stack assemblies are carried on the first surface, the fixed plate of each of the cell stack assemblies being disposed on a top surface of a respective set of protruding ribs of the at least two sets of protruding ribs, a bolt passing through the fixed plate into the threaded blind hole to fix the fixed plate to the top surface of the corresponding set of protruding ribs, and the elastic member and the active plate being disposed in the space defined by the corresponding set of protruding ribs.

5. The loading plate according to claim 2, wherein:
the fluid joint comprises a fuel inlet joint, a fuel outlet joint, an oxidant inlet joint, an oxidant outlet joint, a coolant inlet joint, and a coolant outlet joint; and/or
the elastic member comprises a spring; and/or
at least one of the two ends of each strapping tape is adjustable to the active plate such that the length of the strapping tape extending between the active plate and the second end plate member can be adjusted to adjust a retaining force applied by the strapping tape to the second end plate member and the active plate.

6. A fuel cell system, comprising:
at least two cell stack assemblies, each of the cell stack assemblies comprising a stack laid up by battery cells, a first end plate member and a second end plate member disposed at opposite ends of the stack to grip the stack, and a fluid joint extending from the stack through the first end plate member; and
a loading plate carrying the at least two cell stack assemblies, the loading plate comprising the opposing first surface and second surface, and a plurality of apertures extending from the first surface through the loading plate to the second surface, each of the apertures configured to correspond to one of the fluid joints of the at least two cell stack assemblies;
wherein the at least two cell stack assemblies are carried on the first surface of the loading plate such that the first end plate member of the at least two cell stack assemblies is mounted on the first surface and such that the fluid joints of the at least two cell stack assemblies extend through the plurality of apertures.

7. The fuel cell system according to claim 6, wherein:
the first end plate member of each of the cell stack assemblies comprises:
a fixed plate configured to clamp the stack therebetween with the second end plate member;
an active plate disposed on the opposite side of the fixed plate to the stack; and
an elastic member disposed between the fixed plate and the active plate;
each of the cell stack assemblies further comprising a plurality of strapping tapes with each of the plurality of strapping tapes bypassing the second end plate member and ends connected to the active plate to hold the second end plate member, the stack, the fixed plate, the elastic member, and the active plate together, wherein the plurality of strapping tapes are each in a tight state and the elastic member is each in a compressed state;
the loading plate further comprising at least two recesses in the loading plate recessed from the first surface, each recess configured to correspond to one of the first end plate members of the at least two cell stack assemblies; and
the fixed plate of each of the cell stack assemblies is fixed on the first surface and the elastic member and the active plate are disposed in the recess.

8. The fuel cell system according to claim 7, wherein:
the loading plate further comprising a set of protruding ribs protruding around each of the recesses on the first surface, the protruding ribs including a top surface and a threaded blind hole extending from the top surface into the loading plate through the protruding ribs; and
the fixed plate of each of the cell stack assemblies is mounted on a top surface of a respective set of protruding ribs through which a bolt extends into the threaded blind hole to secure the fixed plate on a top surface of the respective set of protruding ribs, and the elastic member and the active plate are disposed in a space defined by the recess and the respective set of protruding ribs.

9. The fuel cell system according to claim 6, wherein:
a first end plate member of each of the cell stack assemblies comprises:
a fixed plate disposed to grip the stack therebetween with the second end plate member;
an active plate disposed on the opposite side of the fixed plate to the stack; and
an elastic member disposed between the fixed plate and the active plate;
each of the cell stack assemblies further comprising a plurality of strapping tapes with each of the plurality of strapping tapes bypassing the second end plate member and ends connected to the active plate to hold the second end plate member, the stack, the fixed plate, the elastic member, and the active plate together, wherein the plurality of strapping tapes are each in a tight state and the elastic member is each in a compressed state;
the loading plate further comprising at least two sets of protruding ribs protruding from the first surface, the protruding ribs comprising a top surface and a threaded blind bore extending from the top surface into the loading plate through the protruding ribs; and
the at least two cell stack assemblies are carried on the first surface of the loading plate, the fixed plate of each of the cell stack assemblies is disposed on a top surface of a respective set of protruding ribs of the at least two sets of protruding ribs, a bolt extending through the fixed plate into the threaded blind hole of the respective set of protruding ribs to fix the fixed plate to the top surface of the corresponding set of protruding ribs, and the elastic member and the active plate are disposed in a space defined by a corresponding set of protruding ribs.

10. The fuel cell system according to claim 7, wherein:
the at least two cell stack assemblies share a housing mounted on the loading plate to surround and enclose the at least two cell stack assemblies; and/or
the fluid joints comprise a fuel inlet joint, a fuel outlet joint, an oxidant inlet joint, an oxidant outlet joint, a coolant inlet joint, and a coolant outlet joint; and/or
the elastic member comprises a spring; and/or
at least one of the two ends of each strapping tape is adjustable to the active plate such that the length of the strapping tape extending between the active plate and the second end plate member can be adjusted to adjust a retaining force applied by the strapping tape to the second end plate member and the active plate.
